(19) United States
(12) Patent Application Publication
(10) Pub. No.: US 2021/0034030 A1
(43) Pub. Date: Feb. 4, 2021

(54) SCENARIO EDITOR TOOL FOR A CONTROL SYSTEM

(71) Applicant: The GSI Group LLC, Assumption, IL (US)

(72) Inventors: Benoit R. LABERGE, St-Hubert, QC (CA); Yvon Gaudreau, St-Hubert, QC (CA); Nicolas Bégin, St-Hubert, QC (CA); Khaled Saad, Saint-Jean sur Richelieu, QC (CA)

(21) Appl. No.: 16/645,326

(22) PCT Filed: Aug. 3, 2018
(86) PCT No.: PCT/IB2018/055847

§ 371 Date: Mar. 6, 2020

Related U.S. Application Data
(60) Provisional application No. 62/557,179, filed on Sep. 12, 2017.

(51) Int. Cl. G05B 19/042; G05B 19/045; G06F 21/62

(52) U.S. Cl. CPC G05B 19/0425; G06F 21/62; G05B 19/045

(57) ABSTRACT

In one embodiment, a system comprising plural equipment, each of the plural equipment having a different functionality; a controller; and a switch comprising plural states, the switch operably coupling the plural equipment to the controller, wherein the switch, when configured in a first state, enables the controller to control operations of the plural equipment using first control logic, and wherein the switch, when configured in a second state, enables the controller to control operations of one or more equipment of the plural equipment using second control logic that bypasses the first control logic.

### CROSS REFERENCE TO RELATED APPLICATION

This application claims the benefit of U.S. Provisional Application No. 62/557,179 filed Sep. 12, 2017, which is hereby incorporated by reference in its entirety.

### TECHNICAL FIELD

The present disclosure is generally related to control systems, and, more particularly, control systems for farming operations.

### BACKGROUND

Today's large farms require integrated and sophisticated control systems that manage hundreds of inputs and outputs of all kinds. Participants in farming operations include, farm employees, farm owners, integrator, salesmen, service men, feed men, and all of them may need to interfere with the control system on a regular or periodic basis. One or more of these participants may have varying degrees of familiarity with the operation of the control system, some more than others depending on their interest and their access right to controller's settings and data. Because of the vital role control systems play in maintaining an environment suitable for efficient production, interference with such systems may create undesirable conditions.

For instance, some participants in farming operations may be contractors or more generally, referred to as external users such as bird catchers or manure spreader contractors, who come to a farm every 2-3 months and are often unfamiliar with how the control system works. Taking the bird catcher as an illustrative example, when it's time to ship out birds, one goal is to catch (by hand) all birds and put them in cages to be stacked onto a truck trailer that is used to bring the birds to a processing plant. The bird catching operation usually takes 2-4 hours. Since bird catchers are usually not part of a farm payroll (e.g., they travel from site to site on contract), they are typically unfamiliar with the site room controls. Additionally, an owner of a particular farming site usually doesn't want bird catchers or other external users to interfere with the control system.

In a typical bird catching operation, a bird catcher needs the room to be dark and environmental conditions calm to get an advantage over the fast running birds. If the owner is present when the bird catcher gets to a site, the bird catcher may ask for the lights to be dimmed slightly, with inlets cracked to maintain only a minimum amount of ventilation and not allowing day light in. A bird catcher desires a minimum amount of light, typically enough to barely see where he walks. However, if the owner is not present, the bird catcher may attempt to interfere with the controls, the circuit breakers, and/or all available switches to adjust light. Sometimes, when all else fails (and sometimes before), bird catchers simply break light bulbs to achieve their end goal.

### BRIEF DESCRIPTION OF THE DRAWINGS

Many aspects of certain embodiments of the disclosure can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram that illustrates an embodiment of an example control system using a scenario editor tool.

FIG. 2 is a screen diagram that illustrates an example interface of an embodiment of a scenario editor tool for configuring one or more scenario activation external switches.

FIGS. 3A-3B are schematic diagrams that illustrate switching states configured using an embodiment of a scenario editor tool to enable either regular control operations or scenario control operations.

FIGS. 4A-4C are screen diagrams that illustrate example interfaces of an embodiment of a scenario editor tool for setting up scenarios for individual locations.

FIGS. 5A-5C are screen diagrams that illustrate example interfaces of an embodiment of a scenario editor tool for providing feedback of all configured scenarios, including activated scenarios.

FIG. 6 is a schematic diagram that illustrates an embodiment of an example controller for implementing an embodiment of a scenario editor tool.

FIG. 7 is a flow diagram that illustrates an embodiment of an example scenario editor method.

### DESCRIPTION OF EXAMPLE EMBODIMENTS

### Overview

In one embodiment, a system comprising plural equipment, each of the plural equipment having a different functionality; a controller; and a switch comprising plural states, the switch operably coupling the plural equipment to the controller, wherein the switch, when configured in a first state, enables the controller to control operations of the plural equipment using first control logic, and wherein the switch, when configured in a second state, enables the controller to control operations of one or more equipment of the plural equipment using second control logic that bypasses the first control logic.

### DETAILED DESCRIPTION

Certain embodiments of a scenario editor tool are disclosed that enable an operator or owner of a farm to configure a farm control system (herein, also just control system) to serve specific needs for participants in farming operations that have limited or no access rights to the control system, or are unfamiliar with the control system (such participants also referred to herein as external users). Through the configurations enabled by the scenario tool editor (either at the controller or remotely via a web interface) for an authorized user, with a touch of a button by a user having limited or no access rights to the underlying logic of a farm control system (or unfamiliar with the control system), a new mode to a controller is enabled that bypasses the regular control logic in favor of logic dedicated to a specific user, utilization, or generally, scenario. In one embodiment, a system is provided that includes optionally one or more inputs/outputs (I/O) devices coupled to one or more equipment, one or more controllers, and one or more switches, each configured by a scenario editor tool to operate in a state that enables bypass control logic to control the operation of the one or more equipment for a given scenario, the switch further configured to operate in another state that enables regular control operations of the equipment of a farm. In some embodiments, the I/O devices may be omitted, and control between the controller and the equipment is achieved directly. As will be further evident in the description below, the scenario editor tool facilitates the performance of various roles or service operations by certain employees or contractors while maintaining the integrity of the control system.

Digressing briefly, as indicated above, certain service operations in a farm require an adjustment in the control of one or more equipment. In the case of a bird catcher, attempts to alter operations of one or more equipment via interference with a controller may lead to frustration and, potentially, damage to various equipment or even risk of harm to livestock (e.g., poultry, cows, pigs, etc.). Through the use of certain embodiments of a scenario editor tool, an authorized operator or user of the control system may configure one or more switches and one or more equipment to bypass regular control logic and regular equipment operations in favor of a dedicated control circuit that is limited to serving the needs of the particular employee or contractor that is unfamiliar with, or has limited or no access rights to, the regular control logic and yet needs at least some of the functionality (or altered functionality) of the control system to achieve his or her roles. In the case of the bird catcher example described above, the scenario may be set up by an authorized user (using the scenario editor tool) to, at the press of a button (e.g., to change a state of a switch) located proximal to the area where service operations are to take place, dim light (lamp) intensity, restrict outside light (e.g., via control of air inlets), adjust fans for minimal required ventilation, and in general, bypass regular temperature control. The authorized user may use the scenario editor tool to automatically return to regular temperature control at the earlier of the expiration of a defined period (e.g., 2-3 hours duration) or re-selection of the button by the bird catcher (e.g., to deactivate the scenario).

Having summarized certain features of a scenario editor tool of the present disclosure, reference will now be made in detail to the description of a scenario editor tool as illustrated in the drawings. While a scenario editor tool will be described in connection with these drawings, there is no intent to limit it to the embodiment or embodiments disclosed herein. For instance, though emphasis is placed on applications to a farm involving livestock production, it should be appreciated by one having ordinary skill in the art in the context of the present disclosure that certain embodiments of a scenario editor tool may be beneficially deployed in any operation that is computer-controlled where there is a need for restricted access to the control system while enabling certain functionality afforded by the control system. Also, though the scenario editor tool is described in association with handling scenarios using existing equipment and some of the architecture of existing control systems, it should be appreciated by one having ordinary skill in the art in the context of the present disclosure that the functionality of the scenario editor tool may be used at the conception stage of a control system. For instance, many farms use generators that are sized, along with the electrical system (e.g., transformers, wiring), for worst case loads. However, since the scenario editor tool may be used to stage on/off equipment and variable equipment in a judicious manner, a reduction in the designed size of the generator may be implemented, which may considerably reduce the cost of equipment. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the principles and scope of the disclosure as defined by the appended claims. Further, it should be appreciated in the context of the present disclosure that the claims are not necessarily limited to the particular embodiments set out in the description.

Note that reference to a scenario is intended to refer to operations under the control of control logic in the control system that causes all or select equipment to bypass regular operations and operate (or to be stopped) according to a given control scheme (e.g., using modified operating parameters) that enables a particular service to be performed by one having limited or no access rights to the underlying logic of the control system (or being unfamiliar with the control system) used for carrying out the regular functions or operations of the control system. For instance, sometimes a contractor or employee unfamiliar with the control system, or generally, external user, may need to set a selection of outputs in a predetermined state (on off or operating at a certain fix intensity) to execute a specific task or to respond to certain situation, yet he or she wants to do so quickly, at the touch of a button, without spending time adjusting the settings or by-passing the outputs one by one on a user interface. Some specific yet simplistic use cases illustrative of such a scenario include a panic situation, an emergency stop, etc.

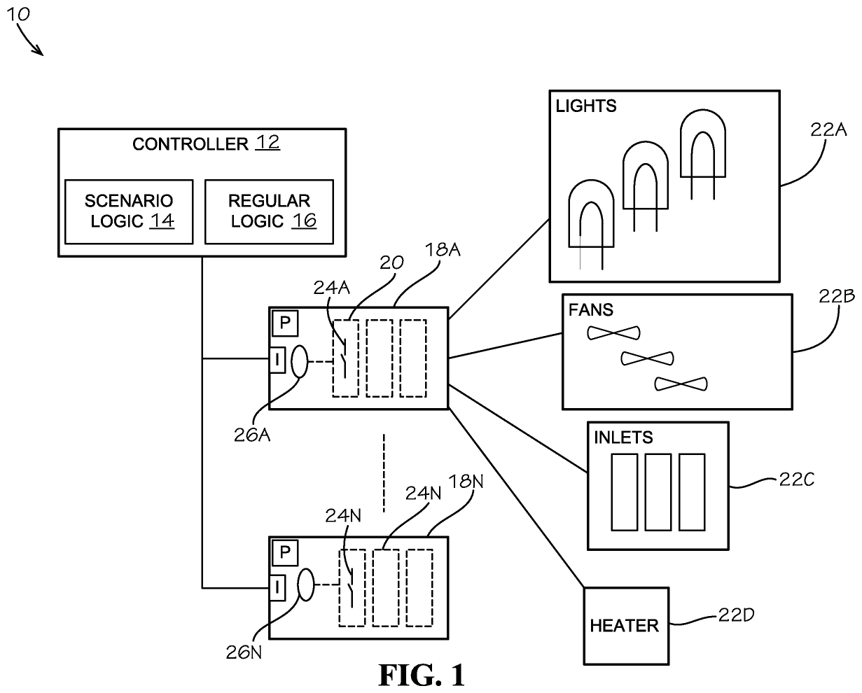

FIG. 1 is a schematic diagram that illustrates an embodiment of an example control system 10 using a scenario editor tool. The control system 10 depicted in FIG. 1 is illustrative of a simple example, and that in some implementations, there may be additional and/or different controls, equipment, and/or circuits. The control system 10 includes one or more controllers, including as depicted, a controller 12 comprising control logic that in the depicted embodiment comprises scenario logic 14 and regular logic 16. In the depicted embodiment, the control system 10 further comprises one or more inputs/outputs (I/O) devices 18A-18N (also referred to herein as expansion boxes), with each I/O device comprising one or more I/O modules 20 that connect to one or more slots of the I/O device 18, the I/O modules 20 comprising plural input and output connections. In some embodiments, the I/O devices 18 may be omitted, with the controller 12 coupled directly to the equipment. The I/O devices 18 and I/O modules 20 may be network-addressable components in some embodiments, enabling the controller 12 to determine their locations and function within a farm. The I/O devices 18 may have a processor (P) that executes firmware, based on commands from the controller 12, to control the outputs. Signaling between the controller 12 and the processors of each I/O device 18 may be via an interface (I) disposed in the I/O device 18 (e.g., using RS-485 or other control protocols). The control system 10 further comprises one or more equipment 22 that are coupled to one or more of the I/O modules 20 of the I/O device(s) 18. In the depicted example control system 10, one or more of the I/O modules 20 of the I/O device 18A are coupled to equipment 22A that includes light equipment, equipment 22B that includes fan equipment, equipment 22C that includes inlet equipment (e.g., to allow or restrict the passage of air into a defined space), and equipment 22A that includes a heater.

In one embodiment, the fans 22B, Inlets 22C, lights 22A, and heaters 22D are all configured using the same type of module (20) that may reside in any of the expansion boxes 18. For instance, there may be 2 types of expansion boxes 18: 3 slots (for 3 modules) and 6 slots (for 6 modules). There may also be 6 types of modules (20) that can be mounted into expansion boxes, where each type comprises a variation of relays (for on-off outputs), 0-10 Vdc analog (for variable outputs) and inputs (e.g., universal inputs, which may include any known type, including resistance, dry contact, 0-5 Vdc, 4-20 mA or pulse). A relay on an expansion box 18 may be coupled to a heater, an on-off single speed fan, an inlet or any other type of load. In some embodiments, relays may reside in each equipment 22, enabling direct control (without the intermediate I/O devices 18) of the equipment 22, or relays may reside in the controller 12 to enable direct control of the equipment 22. Note that other configurations of I/O modules 20 and/or I/O devices 18 (expansion boxes) may be used, and that the description above is for illustration. For instance, there may be a single I/O module 20 coupled to the plural equipment 22A-22D, multiple I/O modules 20 within a single I/O device 18 coupled to the equipment 22A-22D, multiple I/O modules 20 distributed among more than a single I/O device 18 coupled to the equipment 22A-22D, or no I/O modules 20 (e.g., the controller 12 is coupled directly to the equipment 22).

Each equipment 22 has its own virtual switch (not shown) into the controller 12. This virtual switch, which may be accessed via a regular logic interface (e.g., graphical user interface) used to configure a given piece or assembly of equipment 22 (e.g., fan equipment 22B) presented at the controller 12 or other device, enables an authorized user to set the equipment in auto or manual mode. Manual mode enables the equipment to be turned on or off manually.

In certain embodiments of operation using the scenario editor tool, each scenario can be related to many output by-passes. An output can be assigned to be on off or to maintain a certain intensity on a scenario. A scenario can be activated in the controller 12 or by one of the external switches 24 (described further below) to which it is assigned if it is enabled in the controller 12. An external switch 24 can only be assigned to one scenario, but there can be many external switches 24 assigned to a scenario. When a scenario is activated, only outputs for which the virtual switch is on auto can execute the by-pass command as defined in the scenario.

The I/O devices 18A and 18N also comprise (hardware) scenario switches 24A, and 24N, respectively. The switches 24 may be dry contacts that are part of the I/O modules 20. Coupled to the switches 24A, 24N are hardware push-buttons 26A, 26N, respectively. In one embodiment, the push-buttons 26 (or other physical interfaces with a similar function) may be located on (or internal to) an enclosure or housing for the I/O device 18. In some embodiments, the push-buttons 26 may be located elsewhere but coupled to the switches 24. In any case, assuming an authorized user has set (via an interface) the virtual switch to auto and enabled a scenario (using the scenario editor tool as explained below), when an external user presses the push-button 26, a scenario is activated. For instance, in the case of the bird catcher, the push-button 26 may be uniquely identifiable by the bird catcher (e.g., a particular color, a label with the words, such as “bird catcher button”, or other manner of visual or tactile identification). In some embodiments, there may be plural switches 24 for respective plural scenarios within an I/O device 18, in which case there may be a corresponding number of dedicated buttons 26 for the different scenarios. In other words, although a single push-button 26 is shown per I/O device 18, there may be plural push-buttons 26 for respective switches 24 for an I/O device 18. For instance, one push-button 26 may be dedicated to an external user that performs one type of service operation (e.g., one for a user responsible for bird catching), and another push-button 26 (e.g., different label, color, geometry, or other visual or tactile distinction) may be dedicated to another external user that performs a different type of service operation (e.g., feeding service). In some embodiments, a button/switch combination may be replicated at another I/O device 18, such as one located in another location of the farm for the same building (e.g., where the building is long) to enable convenient access and/or redundancy in operation. In some embodiments, the I/O device 18 may comprise a display screen and graphical user interface rendered thereon. In some embodiments, the I/O device 18 may be a processor-based device, as described above.

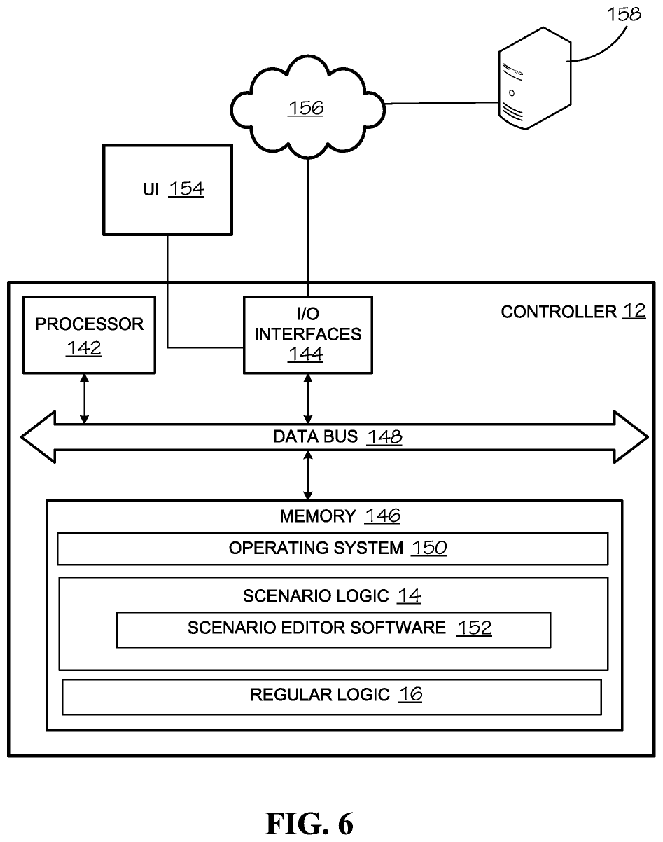

The controller 12 comprises a processor-based computing device that executes software to control the equipment 22 via the I/O devices 18 (or in some embodiments, directly). In one embodiment, the controller 12 communicates commands via an RS-485 protocol (or other protocols in some embodiments) to the I/O devices 18, which in turn manage (e.g., via the processor (P) executing firmware) the outputs of the I/O modules 20. The controller 12, described further in association with FIG. 6, comprises an interface embodied as a display screen and a graphical user interface rendered thereon (not shown in FIG. 1). In one example arrangement, the controller 12 may be located in an office of the farm, the I/O devices 18 may be located in passways, and the equipment 22 are located in one or more production rooms. It should be appreciated by one having ordinary skill in the art that other arrangements of the control system 10 may be implemented, and that the above description is for illustrative purposes. The communications among the components of the control system 10 may be effected using wired (e.g., Ethernet, twisted pair, etc.) and/or wireless (e.g., Bluetooth, 802.11, etc.) communications.

In some embodiments, the functionality of the scenario editor tool may be achieved by a single device or distributed among plural devices. For instance, controller functionality may be implemented, at least in part, using a remote server or cloud computing platform that is in communication with the controller 12 and/or with the I/O devices 18. In some embodiments, such as where the controller 12 is located at the farm, the controller 12 may be accessed via a computing device (e.g., smartphone, laptop, tablet, etc.) from a location remote from the farm and its functionality configured remotely via one or more network connections (e.g., cellular and/or wide area network connection). The controller 12 includes scenario logic 14 and regular logic 16. The scenario logic 14 includes the scenario editor tool and logic (e.g., software and/or firmware) that controls one or more of the user-configured equipment 22 during a scenario. In some embodiments, functionality of the scenario logic 14 and/or regular logic 14 may be achieved entirely within the controller 12, in another device, or distributed among plural devices (e.g., the controller 12 and the I/O devices 18). The regular logic 16 includes logic (e.g., software and/or firmware) to control the plural equipment 22 during regular (non-scenario operations), and includes an editor tool to configure operations of the equipment 22. Note that, though a single controller 12 is shown, a farm may have multiple controllers 12 that are similarly configured and in communication with each other. Note that, although equipment 22 involving lights 22A, fans 22B, inlets 22C, and heaters 22D are described, it should be appreciated by one having ordinary skill in the art, in the context of the present disclosure, that fewer, additional, or other types of equipment 22 may be used. For instance, equipment may include, in addition to, or in lieu of those depicted in FIG. 1, cooling equipment, feed augers, feed delivery equipment, water flush equipment, water pumps, and/or brooders, among others.

In an example operation of execution of the scenario logic 14, based on a prior configuration by an authorized user (using the scenario editor tool to associate a switch 24 with select equipment and operational constraints, or generally, the scenario) and enabled activation, and based on a user (e.g., contractor) selecting the switch(es) 24 (via selection of the button(s) 26, and further assuming configuration by an authorized user of the virtual switch to auto), the regular logic 16 is bypassed, and the scenario logic 14 delivers (and/or removes) signals to one or more of the equipment 22 that are needed by a particular (external) user, the operations of the equipment 22 constrained by the configuration by the user using the scenario editor tool (assuming an auto configuration via the virtual switch). According to the constraints imposed by the authorized user, the end time may be preset, or it may depend on user action (e.g., re-selecting the button 26). Importantly, the external user for a particular service is unable to effect any bypass (i.e., unable to activate the scenario) unless the authorized user has enabled the scenario and the virtual switch is set to auto. Stated otherwise, the scenario needs to be enabled for activation by an authorized user and then activated via selection of the button 26 (e.g., by an external user). By requiring enablement of the scenario by an authorized user, inadvertent (or maliciously intended) selection of the button 26 will not result in activation of the scenario. Also, this requirement of enablement by an authorized user and the external user is helpful even if selection of the button 26 is for reasonable and deliberate intentions, such as to avoid damage to property or livestock (e.g., in the case of inclement weather conditions, premature livestock age, etc.).

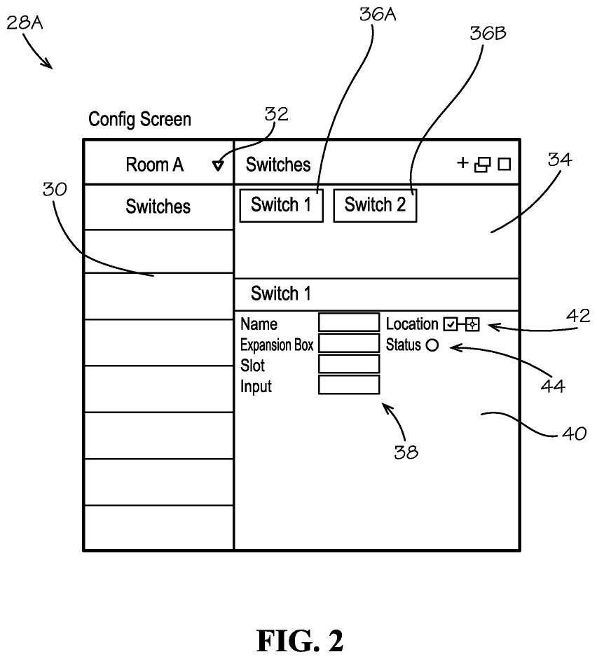

Having generally described an example control system 10, attention is directed to FIG. 2, which shows an example interface 28A of a scenario editor tool for enabling an authorized user to configure one or more external scenario switches (e.g., switch(es) 24, FIG. 1). It should be appreciated by one having ordinary skill in the art, in the context of the present disclosure, that the example interface 28A is illustrative of one example layout, and that in some embodiments, other formats or layouts may be used to enable the configuration of one or more switches (e.g., switches 24). The depicted example interface 28A is for switch configuration for a particular location (e.g., room A), as shown by the columnar panel 30 on the left-hand side of the interface 28A. The panel 30 identifies the control system component being configured, which in this example, are switches (for scenario(s), in our case here). A drop-down menu icon 32 enables the authorized user to select a different location to, for instance, configure switches in those locations. A top panel 34 lists the switches (e.g., switch 1, switch 2), which are currently created and configured. These switches were previously hardwired in one or more I/O devices related to Room A. As shown here, tiles 36A (switch 1) and 36B (switch 2) are created and configured. For instance, the authorized user (or other personnel) may have recorded the presence of the switches 1 and 2, and its location/connections (e.g., I/O device, I/O module, and input number) and now seeks to record that information using the shown configuration page (FIG. 2) at the controller 12 or at another device that renders the interface 28A and is in communication with the controller 12. Upon selection of the switch 1 tile 36A, fields 38 for entering identifying information are presented in a lower panel 40 of the interface 28A for switch 1. In one embodiment, the fields 38 correspond to identifying information that includes a name of switch 1, the expansion box identifier (e.g., the identifier for the I/O device 18), the slot identifier (e.g., for receiving the I/O module 20), and an input identifier. A location field 42 has a checkbox that the authorized user selects to confirm the location in Room A is set (prompting in some embodiments a pop-up of a map of the farm with a node identifying the location in the overall map). A status indicator 44 indicates the number of times the switch has been engaged (for testing wiring and connection). The status indicator 44 may visually distinguish the status of the switch 1 using a different color or intensity or percentage of light fill. Various statuses may be represented, including in addition to whether the switch 1 is on or off, whether the switch is created, validity of the expansion box/slot/input, error conditions, and condition of no configuration or incomplete configuration of the switch 1.

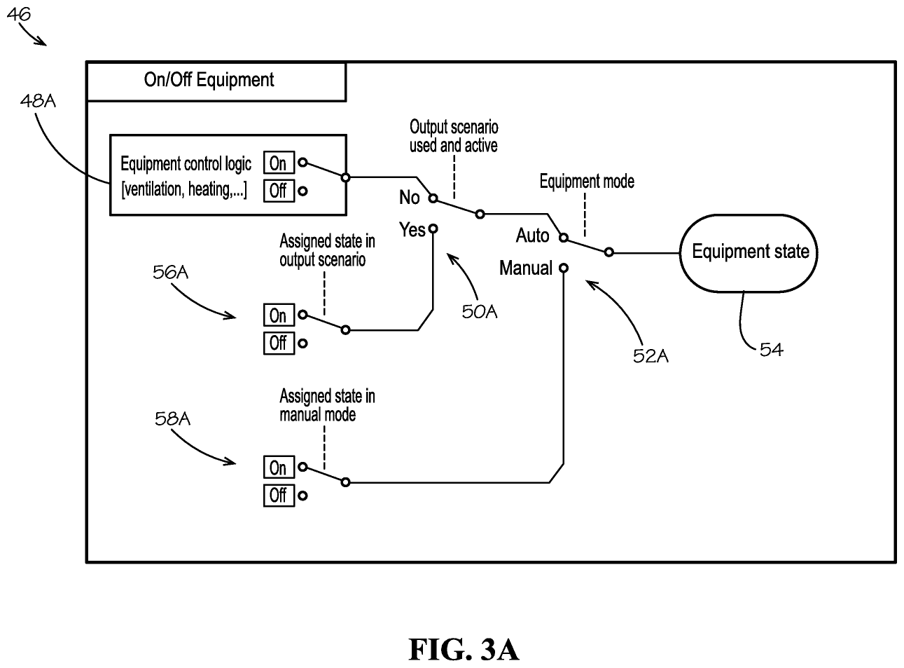

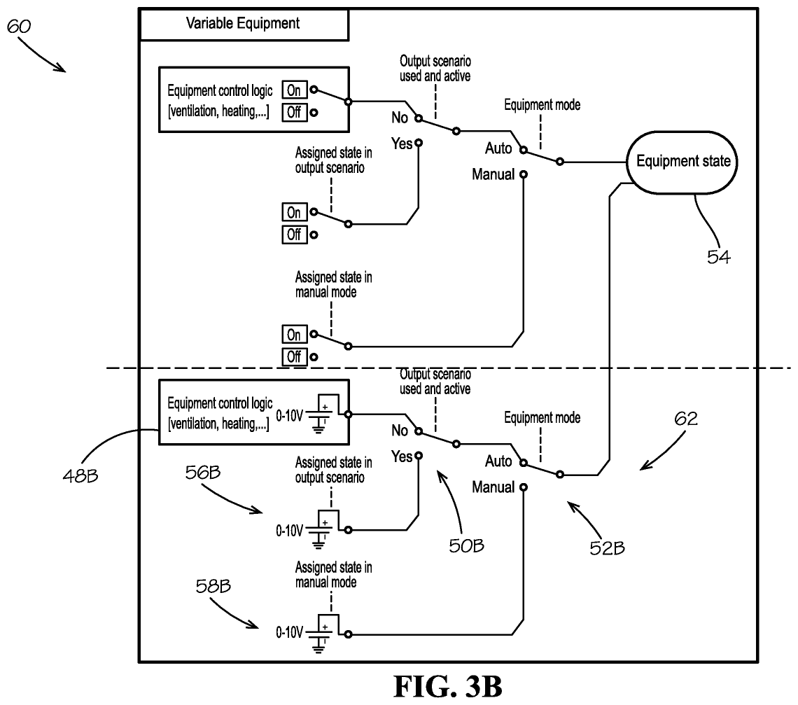

FIGS. 3A-3B are schematic diagrams that illustrate switching states configured using an embodiment of a scenario editor tool to enable either regular control operations or scenario control operations. FIGS. 3A-3B are somewhat an extension of what is shown in FIG. 1. Referring to FIG. 3A, shown is a logical circuit 46 for controlling on/off equipment. From left to right in FIG. 3A, shown is the equipment control logic 48A (e.g., the same or similar to regular logic 16 of FIG. 1), which is configurable in either an on state or an off state. In this example, the equipment control logic 48A is configured in an on-state. The equipment control logic 48A is connected to bypass switch 50A. Bypass switch 50A is the same or similar to switch 24 in FIG. 1. The bypass switch 50A is configurable in either an on state or an off state, and in the depicted example, is in the off state (“No”). Shown to the right of the bypass switch 50 is an equipment mode switch 52A (e.g., the virtual switch referred to above). The equipment mode switch 52A is coupled between the equipment 22 (FIG. 1), shown as equipment state 54, and the bypass switch 50A, and is configurable in either the auto mode or manual mode (with configuration in the auto mode shown in FIG. 3A). Thus, in the states shown configured in FIG. 3A, the equipment control logic 48A is in regular operations (no bypass mode) to control, using the auto mode and in one embodiment, the I/O module 20, the equipment states 54. Shown beneath the equipment control logic 48 are the scenario on/off controls 56A (e.g., the same or similar to scenario logic 14 of FIG. 1), and is shown in an on state. If the bypass switch 50A is switched to on (“Yes”) (e.g., by a user selecting the button 26 in FIG. 1) and the equipment mode switch 52A is configured to the auto state, the control of the equipment state 54, which is enabled (e.g., having an on-state), is achieved via the scenario on/off controls 56A (in one embodiment, used in conjunction with the I/O module 20) as configured by an authorized user using the scenario editor tool. Note that one of the interfaces described below enables the authorized user to select which of the equipment is to be bypassed for a scenario, and if not selected and the virtual switch is configured at auto, operation for that equipment continues to work according to regular logic control if the scenario is active. Shown beneath the scenario on/off controls 56A is a manual on/off control 58A, which is shown configured in the on state. If the equipment mode switch 52A has a state of manual control, then control of the equipment state 54 is achieved via the manual on/off control 58A.

Referring to FIG. 3B, shown is a logical circuit 60 for controlling variable equipment (and on/off equipment). As noted by the dashed line running horizontally across FIG. 3B, the logical circuit 60 comprises the top logical circuit 46 (above the dashed line) discussed above in association, description here of which is omitted for brevity. The logical circuit 60 also comprises the lower logical circuit 62 (i.e., shown beneath the dashed line), which comprises variable control for the equipment state 54 (e.g., in one embodiment implemented using variable outputs of the I/O module 20). Referring specifically to the logical circuit 62, and looking from left to right, the equipment control logic 48B comprises a variable control component (shown as 0-10V, though can be other values or form of variable control). Shown to the right of the equipment control logic 48B is the bypass switch 50B, configurable in either an off (“No”) state or an on (“Yes”) state, and depicted in the off state. To the right of the bypass switch 50B is the equipment mode switch 52B, shown configurable in either the auto mode or the manual mode (depicted in the auto mode). Shown beneath the equipment control logic 48B is the scenario variable control 56B. When the bypass switch 50B is in the on-state (“Yes”) and the equipment mode switch 52B is in auto mode (or state), the scenario variable control 56B provides for variable control (e.g., as configured using the scenario editor tool and implemented, in one embodiment, via variable control outputs of the I/O module 20) of the variable equipment in the equipment state 54. Shown beneath the scenario variable control 56B is the manual variable control 58B. When the manual mode is enabled (e.g., via equipment mode switch 52B), the manual variable control 58B provides for variable control of the variable equipment of equipment state 54. In the depicted configuration for the logical circuit 62 shown in FIG. 3B, the equipment control logic 48B is in regular (non-bypass) control mode by virtue of the bypass switch 50B being configured in the off (“No”) state and the auto state configuration of the equipment mode switch 52B, enabling variable control of variable equipment (e.g., variable light intensity, variable fan speed, etc.). As shown in FIGS. 3A-3B, the scenario control (and regular control) may be via on/off, variable, or a combination of on/off and variable control schemes. Note that suffixes A and B are used to distinguish different functionality for a common component (e.g., on/off and variable control are achieved via the equipment control logic 48 handling on/off (A) and variable (B) control).

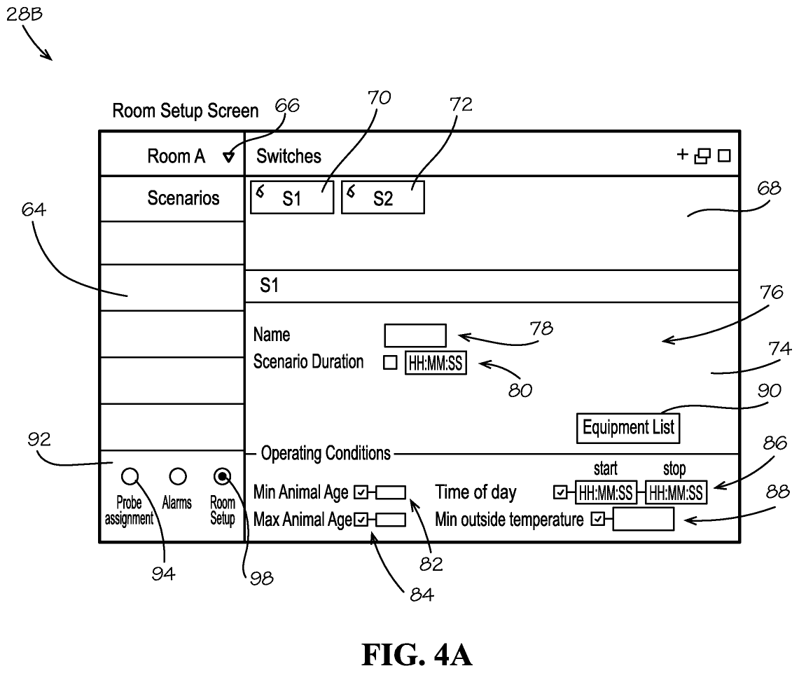

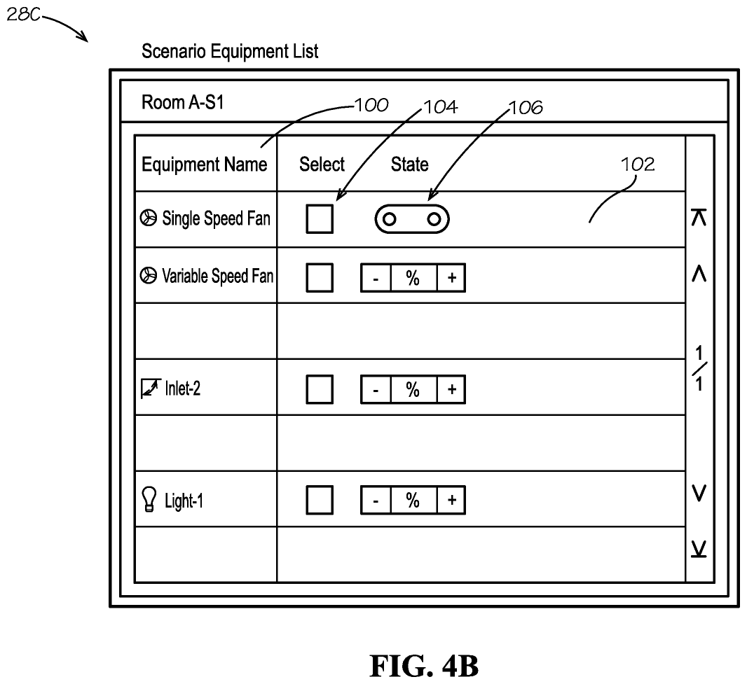

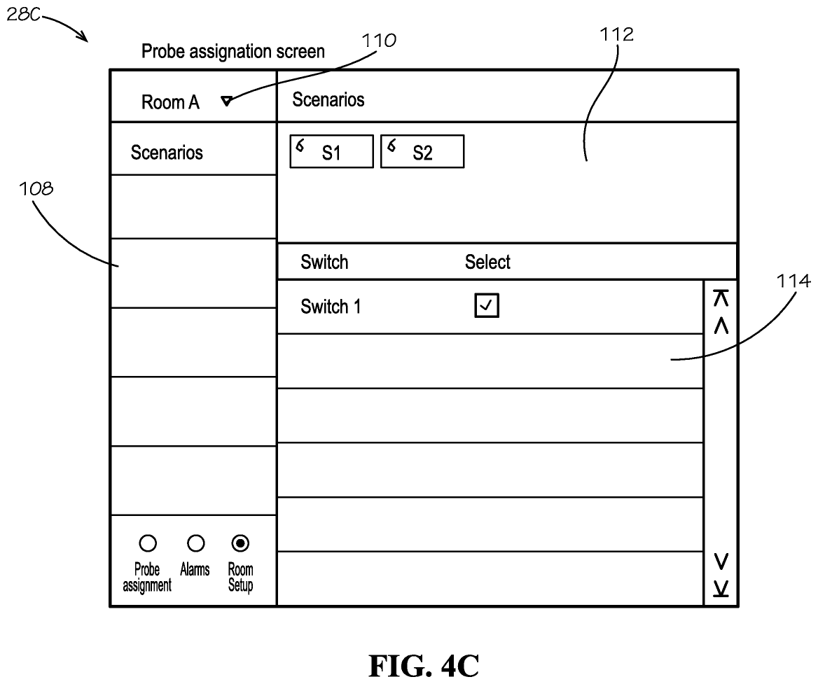

Having shown the operation of regular and scenario control operations, attention is directed to example interface screens of a scenario editor tool that are used to configure scenarios associated with the configured switches. Referring to FIG. 4A, shown is an interface 28B for configuring one or more scenarios for a particular location (e.g., Room A in this example). Responsive to a Room Setup button being hit, a view with a columnar panel 64 identifies the component for configuration (e.g., scenarios) in Room A, and a scroll down menu icon 66 enables an authorized user to configure scenarios for other locations. A top panel 68 lists the scenarios available (created and configured) for configuration in Room A, including scenarios S1 (though depicted with name S1, the scenarios may be given any name) corresponding to an S1 tile 70 and scenario S2 corresponding to an S2 tile 72. Responsive to an authorized user selecting the S1 tile 70, scenario panel 74 provides configuration fields 76 for an authorized user to select or fill in to configure the scenario associated with scenario S1. The fields 76 include a name field 78 to enable the user to enter a name for the scenario. The fields also include scenario duration fields 80 to enable the user to turn on a duration feature (e.g., via a checkbox selection) and enter a duration prescribing a period of time during which (assuming in auto and bypass modes, FIGS. 3A-3B) the scenario, once activated by a user selecting a switch, remains on. If check box is not selected, that means that scenario will last as long as it has not been manually enabled or deactivated by the external switch. The fields 76 also include configurable prerequisites or operation condition fields, including minimal animal age fields 82, maximum animal age fields 84, time of day fields 86, and minimum operating temperature fields 88. Referring to minimal animal age fields 82, a checkbox selection enables this feature, and another field enables entry of the animal minimum age, before which the scenario is prevented from starting in auto mode. The maximum animal age fields 84 also include a checkbox for selection of this feature, and another field for entry of a maximum age beyond which the scenario is prevented from starting in auto mode. The time of day fields 86 comprises a checkbox for selection of this feature, and start and stop fields for entry of a time of day when the scenario may be started and stopped, respectively (the latter stop field also preventing the starting of the scenario) when in auto mode. The minimum operating temperature fields 88 also comprise a checkbox for selection of this feature and a field to enter a temperature, below which the scenario will not be started in auto mode. Also included in the panel 74 is an equipment list tile 90, which opens a scenario equipment list popup as described below in association with FIG. 4B.

Shown located beneath the panel 64 is an options panel 92, which includes selectable button icons for external switch assignment to a scenario 94 (described below in association with FIG. 4C) and room setup 98, which is currently selected for the room configuration screen or interface 28B.

Responsive to an authorized user selecting the equipment list tile 90, the interface 28C is presented as shown in FIG. 4B. As with all of the interfaces described herein, in some embodiments, different manners of layout, format, etc. may be used to meet the intended functionality. The interface 28C comprises a mechanism for selecting the scenario equipment to be used during a particular scenario. As shown in the header of the interface 28C, this particular screen is for configuring the scenario equipment associated with scenario S1, Room A. Columnar panel 100 shown on the left hand side in FIG. 4B lists all available equipment (e.g., equipment 22 in FIG. 1). In other words, the equipment listed in panel 100 includes the equipment available in room A under regular control and available for selection in scenario control, and includes in this illustrative example single speed fans, variable speed fans, inlets, and lights. To the right in FIG. 4B of panel 100 is panel 102, which includes a column of checkboxes 104 for selecting one or more of the corresponding equipment presented in the adjacent panel 100 for use in the scenario for Room A, scenario S1. As described above, equipment that is unchecked here is equipment not assigned to be bypassed, and continues to work under regular operation (assuming auto mode), even if a scenario is active. Adjacent the column of checkboxes 104 is a column of states 106 for each of the equipment listed in the panel 100. For instance, since the single speed fan listed under panel 100 operates according to on/off control, the authorized user can select whether the state is to be on or off under states column 106. As another example, since the variable speed fan listed in the equipment under panel 100 operates according to variable speed control, the authorized user can increment or decrement the degree or intensity of variability for that selected piece of equipment to configure the equipment for the scenario for Room A, scenario S1.

Referring to FIG. 4C, shown is an interface 28D responsively presented based on selection in the interface 28B in FIG. 4A of the probe assignment button icon 94. The interface 28D serves the functionality of an external switch(es) assignment screen, and includes a panel 108 (shown on the left hand side) that indicates that this interface 28D is for scenario configuration (S1 or S2) for room A. The panel 108 includes a scroll down menu icon 110 to select a different location. Shown in the top panel 112 (to the right of panel 108) is a list of configured scenarios (configured in the interface 28B of FIG. 4A) in Room A (e.g., S1 and S2), and panel 114 enables the authorized user to assign switch 1 (configured in interface 28A, FIG. 2) to scenario S1. In other words, the configured scenario S1 is associated with external scenario switch 1 (and can be associated additionally with other external scenario switches) configured in FIG. 2. Assuming the logical circuit 46 (or 60) of FIGS. 3A-3B are in auto mode, when a user with limited or no access rights (or unfamiliar with the control system 10) hits the button associated with external scenario switch 1, the bypass mode is activated based on the prior configuration of external scenario switch 1 and scenario 1 and their association, and scenario operations are implemented using the equipment selected in the interface 28C of FIG. 4B and subject to the constraints or conditions inputted in the interface 28B of FIG. 4A.

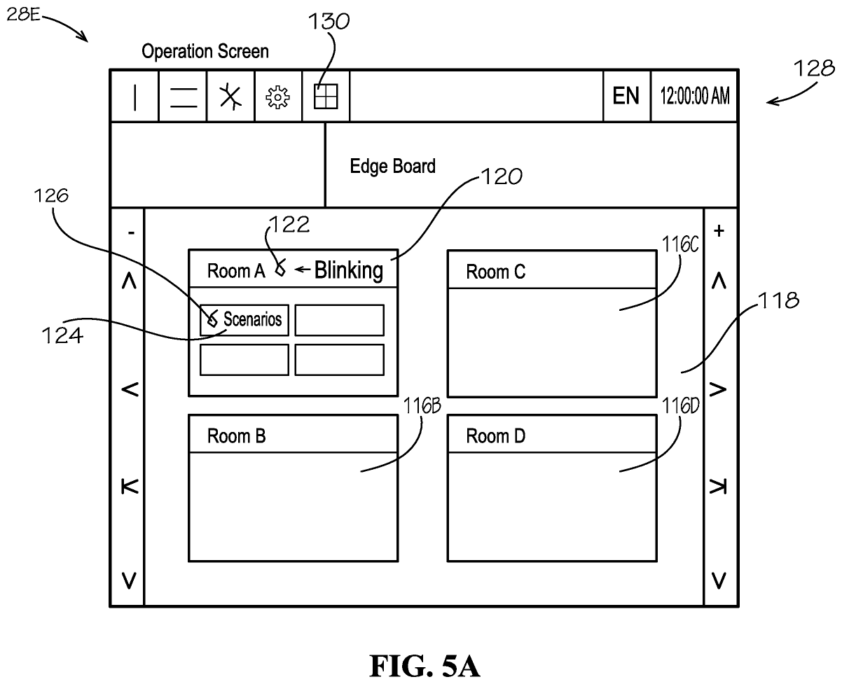

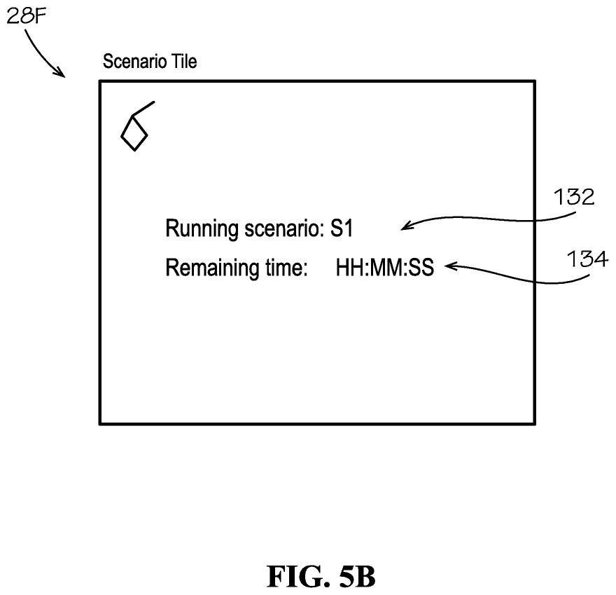

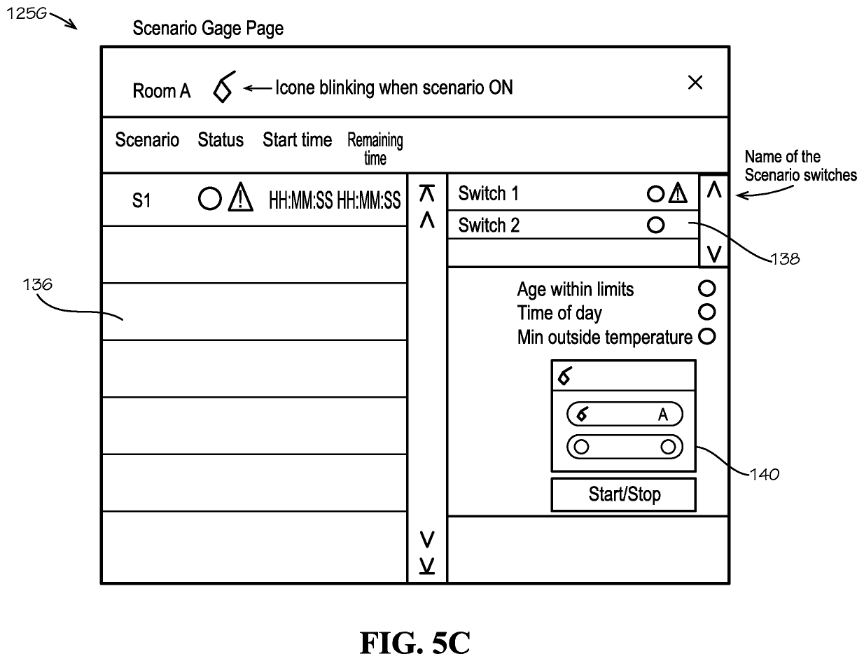

Attention is now directed to FIGS. 5A-5C, which illustrate example interfaces of a scenario editor tool for providing feedback of activated scenarios (or permit an overall view of locations where scenarios have been set up, even if not activated). FIGS. 5A and 5B are screen diagrams that illustrate example interfaces of an embodiment of a scenario editor tool for providing feedback of activated and inactive scenarios. In particular, FIG. 5A shows that a main page icon 130 of the main menu is flashing when the scenario is active in one room. FIG. 5A also shows a “scenario clap” icon 122 flashing on the related room tile headline (room where scenario is active, in this example, Room A). FIG. 5B shows a tile corresponding to the name of the active scenario and the remaining active time of the scenario on the tile of the related room (in this example, room A) on the main page. FIG. 5C is the scenario page displayed when the Scenario tile is hit: it shows the scenarios configured for this room, their status (activated or not—with the remaining time if they are activated) and the stage of the conditions that may interfere with their activation (state of the pre-requisites). The enabling and activation switch widgets for scenarios are also shown on this page.

Explaining further, and referring again to FIG. 5A, shown is an interface 28E that provides functionality of an operations screen. In particular, the interface 28E provides an overview of all locations which operate under control of the control system (e.g., control system 10, FIG. 1). In the depicted example, shown are four tiles 116 (e.g., 116A, 116B, 116C, and 116D for locations including rooms A, B, C, and D, respectively) in main panel 118, where scroll bars and/or navigation icons adjacent the borders of the panel 118 enable a user to quickly view any additional locations where scenarios have been configured. Within each tile 116 are additional tiles (e.g., sub-tiles) that provide feedback of the most pertinent information about control, including the types of equipment, scenarios, sensors, etc. A header of each tile 116 provides an identity of the location (e.g., room A, B, etc.), and may further include an icon that provides visual feedback of a currently implemented scenario. For instance, for tile 116A (room A), a header 120 is presented with a blinking icon 122 to represent that a scenario is on. In some embodiments, other mechanisms for providing visual feedback of an on-scenario may be presented. In this example, the tile 124 (sub-tile) within tile 116A is labeled as a scenario, with a status icon 126 visually indicating that the scenario is on (e.g., via blinking light, green light, or other visual mechanism). Note that the interface 28E further includes a banner 128, which also provides visual feedback as to whether a scenario is on. For instance, shown in the banner 128 is an icon 130 (main screen icon), which is blinking to indicate that a scenario under control of the control system 10 is active (e.g., scenario corresponding to tile 124 in room A (tile 126A)).

A user may select the tile 124, which prompts another interface 28F shown in FIG. 5B. The interface 28F comprises two fields 132 and 134 corresponding to an identification of the scenario (e.g., S1) and the time remaining 134, respectively (e.g., based on the duration set in interface 28B, FIG. 4A). If the user selects the interface 28F, another interface 28G is presented, as shown in FIG. 5C. The interface 28G of FIG. 5C presents additional information about the scenario that is on in Room A, including panel 136 providing information shown in the interface 28F of FIG. 5B along with a status icon(s) of all the scenarios configured for this room. By hitting the line of a selected scenario, the line color changes and some more information relative to this selected scenario appear. For instance, on panel 138 appears the external scenario switches that are associated with the scenario S1 along with a status icon for whether the switch has been activated in the scenario. Also shown is a panel 140 showing an overview of the conditions or constraints for the scenario (e.g., as configured in interface 28B of FIG. 4A) and the equipment and corresponding state (as configured in interface 28C of FIG. 4B).

Having described an example of how the scenario editor tool is used to configure scenarios and provide feedback of scenario operations, attention is directed to FIG. 6, which illustrates an embodiment of an example controller 12. The controller 12 is a processor (or multi-processor) based device that uses software, and/or firmware in some embodiments, to render graphical user interfaces of the scenario editor tool on a display screen for enabling an authorized user to configure one or more scenarios for one or more locations. Note that in one embodiment, the software editor tool may be implemented entirely in the controller 12, or in some embodiments, functionality of the scenario editor tool may be implemented in multiple devices (e.g., the controller 12 and another computing device, such as the I/O device 18, FIG. 1, another controller, and/or other devices). One having ordinary skill in the art should appreciate in the context of the present disclosure that the controller 12 is illustrative of one example, and that some embodiments of controllers may comprise fewer or additional components, and/or some of the functionality associated with the various components depicted in FIG. 6 may be combined, or further distributed among additional modules and/or computing devices, in some embodiments. The controller 12 is depicted in this example as a computer device, but may be embodied as a programmable logic controller (PLC), field programmable gate array (FPGA), application-specific integrated circuit (ASIC), among other devices. In some embodiments, functionality of the controller 12 may be implemented using two or more devices. It should be appreciated that certain well-known components of computer devices are omitted here to avoid obfuscating relevant features of the controller 12.

In one embodiment, the controller 12 comprises one or more processors, such as processor 142, input/output (I/O) interface(s) 144, and memory 146, all coupled to one or more data busses, such as data bus 148. The memory 146 may include any one or a combination of volatile memory elements (e.g., random-access memory RAM, such as DRAM, and SRAM, etc.) and nonvolatile memory elements (e.g., ROM, Flash, hard drive, EPROM, EEPROM, CDROM, etc.). The memory 146 may store a native operating system, one or more native applications, emulation systems, or emulated applications for any of a variety of operating systems and/or emulated hardware platforms, emulated operating systems, etc. In the embodiment depicted in FIG. 6, the memory 146 comprises an operating system 150, scenario logic 14, and regular logic 16, the scenario logic 14 comprising a scenario editor tool 152. The scenario editor tool 152 comprises executable code (e.g., instructions) that provides the underlying functionality for enabling the configuration of switches and scenarios according to interfaces 28A-28G of FIGS. 2 and 4A-5C. The scenario logic 14 and regular logic 16 provide the control strategy (e.g., on/off, variable) to cause the equipment 22 to operate according to configured constraints and/or feedback from sensors. In some embodiments, memory 146 may include one or more additional software modules, including a communications module to enable remote connection to a server or other devices over a network or otherwise wired or wireless medium, including communication with satellites, cellular and/or radio communications with one or more devices, including near filed communications (e.g., Bluetooth, Zigbee, etc.) in conjunction with a transceiver (e.g., satellite transceiver, radio or cellular modem, near filed communications receiver, etc.). In some embodiments, fewer software modules (e.g., combined functionality, omitted functionality) may be employed (or omitted) in the memory 146 or used in additional memory. In some embodiments, a separate storage device may be coupled to the data bus 148 or accessed from locations in a network that enable such access by the controller 12 via the I/O interfaces 144, such as a persistent memory (e.g., optical, magnetic, and/or semiconductor memory and associated drives).

The controller 12 is further coupled via the I/O interfaces 144 to a user interface (UI) 154. In some embodiments, as described above, the controller 12 may be in communication via a network 156 (e.g., one or a combination of a wide area network, local area network, personal area network, wireless carrier and/or telephony network, cable networks, satellite network, etc.) with one or more other computing devices, such as server device 158. For instance, one or more functionality of the scenario editor tool 152 (or in general, scenario logic 14 and/or regular logic 16) may be distributed among the controller 12 and the server device 158 (and/or other devices, including a smartphone, tablet, laptop, etc.).

Execution of the scenario logic 14 (including scenario editor tool 152) and regular logic 16 may be implemented by the processor 142 under the management and/or control of the operating system 150. The processor 142 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 12.

The I/O interfaces 144 provide one or more interfaces to communicatively coupled (wireless or wired) devices, including access to one or more devices coupled to one or more networks 156 and/or to the controller 12. In other words, the I/O interfaces 144 may comprise any number of interfaces for the input and output of signals (e.g., comprising analog or digital data) for receipt or conveyance of information (e.g., data) over one or more networks. The I/O interfaces 144 may include communication functionality, including a radio or cellular modem or other communication functionality utilizing Bluetooth, 802.11, near field communications (NFC), or wired protocol mechanisms (e.g., FTP, HTTP, MPEG, AVC, DSL, ADSL, etc., or derivatives or variants thereof).

The user interface (UI) 154 may include one or any combination of a keyboard, joystick (e.g., with tactile motor), headset, mouse, microphone, display screen, touch-type or otherwise, among other types of input devices.

When certain embodiments of the controller 12 are implemented at least in part as software (including firmware), as depicted in FIG. 6, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 12 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

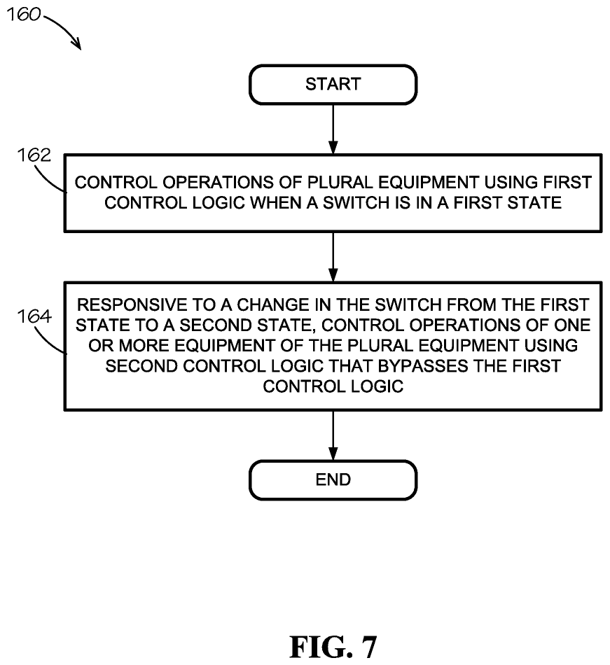

In view of the above description, it should be appreciated that one embodiment of a scenario editor method, depicted in FIG. 7, denoted as method 160, and executed by at least controller 12, comprises: controlling operations of plural equipment using first control logic when a switch is in a first state (162); and responsive to a change in the switch from the first state to a second state, controlling operations of one or more equipment of the plural equipment using second control logic that bypasses the first control logic (164).

Note that the interfaces described herein for the controller 12 (FIG. 1) may enable configurations at the controller 12, or via an interface of another device (e.g., via a web interface via connection to the Internet or other network).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the systems and methods have been described with reference to the example embodiments illustrated in the attached figures, it is noted that equivalents may be employed and substitutions made herein without departing from the scope of the disclosure as protected by the following claims.

At least the following is claimed:

1. A system, comprising:
plural equipment, each of the equipment having a different functionality;
a controller; and
a switch comprising plural states, the switch operably coupling the plural equipment to the controller, wherein the switch, when configured in a first state, enables the controller to control operations of the plural equipment using first control logic, and wherein the switch, when configured in a second state, enables the controller to control operations of one or more equipment of the plural equipment using second control logic that bypasses the first control logic.

2. The system of claim 1, further comprising one or more interfaces, the one or more interfaces enabling configuration of the first and second control logic and the switch by a user with access rights to the first and second control logic and the switch configuration, the one or more interfaces further enabling the user to enable and disable the switch.

3. The system of claim 2, wherein responsive to the switch being enabled by the user with access rights, the state of the switch is configured to be changed by a user without access rights, limited access rights, or with insufficient familiarity about the first and second control logic, enabling operational control to change from the first control logic to the second control logic.

4. The system of claim 3, wherein the switch is coupled to a button uniquely corresponding to one service operation among a plurality of different service operations, success of the one service operation correlated to the controller controlling operations of the one or more equipment of the plural equipment using the second control logic.

5. The system of claim 4, further comprising an input/output device or devices coupled between the controller and the plural equipment.

6. The system of claim 5, further comprising an enclosure housing the input/output device or devices, wherein the button is mounted on the housing or within the housing.

7. The system of claim 2, wherein the one or more interfaces enable, for the switch, the user to enter one or any combination of an identification of the switch, a location of the switch, a duration that the switch is enabled, or one or more prerequisites for enabling the switch.

8. The system of claim 2, wherein the one or more interfaces enable, for the switch, the user to select one or any combination of which of the plural equipment are operational upon activation of the switch, whether the selected one or more of the plural equipment are off or on, or a variable value of intensity for the one or more of the plural equipment.

9. The system of claim 2, wherein the one or more interfaces provide a visual indication of whether a bypass of the first control logic is currently being implemented.

10. The system of claim 2, wherein the one or more interfaces provide visual feedback of information about the configuration of the second control logic and the switch.

11. The system of claim 2, wherein the one or more interfaces comprise a display screen coupled to the controller.

12. The system of claim 2, wherein the one or more interfaces comprise a display screen of the controller.

13. The system of claim 1, further comprising one or more additional switches, each of the one or more additional switches comprising plural states, each of the one or more additional switches operably coupling the plural equipment to the controller, wherein for any one of the one or more additional switches, when configured in a first state, enables the controller to control operations of the plural equipment using first control logic, and when configured in a second state, enables the controller to control operations of one or more equipment of the plural equipment using different control logic that bypasses the first control logic.

14. The system of claim 13, wherein each of the switches is coupled to a respective button uniquely corresponding to a respective one of the plurality of different service operations.

15. A method, comprising:
controlling operations of plural equipment using first control logic when a switch is in a first state; and
responsive to a change in the switch from the first state to a second state, controlling operations of one or more equipment of the plural equipment using second control logic that bypasses the first control logic.

16. The method of claim 15, further comprising enabling, via one or more interfaces:
configuration of the first and second control logic and the switch by a user with access rights to the first and second control logic and the switch configuration; and
the user to enable and disable the switch.

17. The method of claim 16, wherein responsive to the switch being enabled by the user with access rights, enabling the state of the switch to be changed by a user without access rights, limited access rights, or with insufficient familiarity about the first and second control logic to enable operational control to change from the first control logic to the second control logic.

18. The method of claim 17, wherein enabling the state of the switch to be changed by the user without access rights, limited access rights, or with insufficient familiarity about the first and second control logic comprises receiving input corresponding to a button coupled to the switch.

19. The method of claim 16, further comprising enabling, via the one or more interfaces, one or any combination of:
input by the user, the input corresponding to one or any combination of an identification of the switch, a location of the switch, a duration that the switch is enabled, or one or more prerequisites for enabling the switch, selection of one or any combination of which of the plural equipment are operational upon activation of the switch, whether the selected one or more of the plural equipment are off or on, or a variable value of intensity for the one or more of the plural equipment; and
feedback of whether a bypass of the first control logic is currently being implemented; or
feedback of information about the configuration of the second control logic and the switch.

20. A non-transitory computer readable medium comprising instructions that, when executed by one or more processors, causes the one or more processors to:
control operations of plural equipment using first control logic when a switch is in a first state; and
responsive to a change in the switch from the first state to a second state, control operations of one or more equipment of the plural equipment using second control logic that bypasses the first control logic.
